(19) United States
(12) Patent Application Publication
(10) Pub. No.: US 2021/0277654 A1
(43) Pub. Date: Sep. 9, 2021

(54) HEARTWOOD FOR SANDWICH PANEL, SANDWICH PANEL, AND METHOD FOR PRODUCING SANDWICH PANEL

(71) Applicant: LG Hausys, Ltd., Seoul (KR)

(72) Inventors: Sang-Hyun RHO, Anyang-si, Gyeonggi-do (KR); Myung LEE, Suwon-si, Gyeonggi-do (KR); Ji-Won LIM, Seoul (KR)

(21) Appl. No.: 16/334,531

(22) PCT Filed: Jun. 21, 2017
(86) PCT No.: PCT/KR2017/006530

§ 371 Date: Mar. 19, 2019

(30) Foreign Application Priority Data
Sep. 20, 2016 (KR) 10-2016-0120277

(51) Int. Cl. E04C 2/28; D01F 6/62; D01F 8/14; B32B 15/14

(52) U.S. Cl. CPC E04C 2/28; D01F 6/62; D01F 8/14; B32B 2262/12; B32B 2250/03; B32B 2262/0276; B32B 2250/40; B32B 15/14

(57) ABSTRACT

Provided is heartwood for a sandwich panel, comprising: a first polyester-based fiber which is a monocomponent fiber; and a second polyester-based fiber which is a sheath-core type bicomponent fiber. Also provided is a sandwich panel comprising: heartwood derived from the heartwood for a sandwich panel; and a surface material disposed on the sides of the heartwood. Further provided is a method for producing the sandwich panel, comprising: a step of mixing the first polyester-based fiber which is a monocomponent fiber and the second polyester-based fiber which is a sheath-core type bicomponent fiber; a step of producing the heartwood from the mixed fibers by a dry production process; and a step of heating and pressuring the heartwood.

### TECHNICAL FIELD

The present disclosure relates to a core material for a sandwich panel, a sandwich panel that is manufactured using the core material for a sandwich panel, and a method for manufacturing a sandwich panel.

### BACKGROUND ART

A sandwich panel that may be lighter and have a similar level of structural rigidity with respect to metallic beams having the same structure has been widely used in different industrial fields.

The sandwich panel has a structure in which a core layer such as a resin material, a foam resin material, a fiber reinforced composite material, a balsa wood structure, a honeycomb structure, and the like is disposed between two skin layers of metal, wood, plastic, and the like. A sandwich panel that includes a foam resin material as a core layer becomes lighter while having very low mechanical strength. A sandwich panel that includes a fiber reinforced composite material where a matrix resin is impregnated into a reinforcing fiber as a core layer may not become lighter while having high mechanical strength. Additionally, a sandwich panel in which a fiber reinforced composite material, a balsa wood structure, a honeycomb structure, and the like is used as a core layer has a low elongation rate and low formability, and, therefore, may not be used in the field that requires a process in which materials are formed into different shapes.

In particular, a sandwich panel that includes a fiber reinforced composite material as a core layer has high mechanical strength while having low formability because glass fiber or carbon fiber is used as fiber of the fiber reinforced composite material.

### DISCLOSURE

### Technical Problem

In one embodiment of the present disclosure, a core material for a sandwich panel is provided which may become lighter and have high mechanical strength and high formability.

In another embodiment of the present disclosure, a sandwich panel that includes a core material derived from the core material for a sandwich panel is provided which may become lighter and be easily formed into a desired shape through the deep drawing process while maintaining an interfacial bond between layers.

In yet another embodiment of the present disclosure, the method for manufacturing a sandwich panel is provided, thereby making it possible to manufacture a sandwich panel that may become lighter and may have uniform physical properties across the surface area thereof, durability, high formability and high mechanical strength.

### Technical Solution

In one embodiment of the present disclosure, a core material for a sandwich panel is provided which includes a first polyester-based fiber that is a monocomponent fiber; and a second polyester-based fiber that is a sheath-core type bicomponent fiber.

In another embodiment of the present disclosure, a sandwich panel is provided which includes a core material derived from the core material for a sandwich panel; and a surface material disposed on both surfaces of the core material.

In yet another embodiment of the present disclosure, a method for manufacturing the sandwich panel is provided which includes mixing a first polyester-based fiber that is a monocomponent fiber and a second polyester-based fiber that is a sheath-core type bicomponent fiber; manufacturing a core material from the mixed fibers with the dry processing method; and heating and pressurizing the core material.

### Advantageous Effects

The core material for a sandwich panel may become lighter, thereby making it possible to manufacture a sandwich panel that is light and have high mechanical strength and high formability.

The sandwich panel may become lighter and be easily formed into a desired shape through the deep drawing process while maintaining an interfacial bond between layers because the sandwich panel includes a core material derived from the core material of a sandwich panel.

A sandwich panel that is manufactured using the method for manufacturing a sandwich panel may become lighter and may have uniform physical properties across the surface area thereof, durability, high formability and high mechanical strength.

### DESCRIPTION OF DRAWINGS

FIG. 1 is a schematic view illustrating a cross section of a sandwich panel according to one embodiment of the present disclosure.

FIG. 2 is a schematic view illustrating a first polyester-based fiber and a second polyester-based fiber of a core material for a sandwich panel according to one embodiment of the present disclosure.

FIG. 3 is a schematic view illustrating a cross section of a second polyester-based fiber, cut in a direction perpendicular to a length-wise direction of the second polyester-based fiber according to one embodiment of the present disclosure.

FIG. 4 is a schematic view illustrating a cross section of a sandwich panel according to another embodiment of the present disclosure.

FIG. 5 is an SEM image illustrating a cross section of a core material of a sandwich panel manufactured in embodiment 1.

FIG. 6 is a view illustrating a cross section of a desired shape by the process of deep drawing in embodiment 2.

### BEST MODE

Advantages and features of the present disclosure, and a method for implementing the advantages and features will be apparent from below-described embodiments. However, the present disclosure may be implemented in many different forms and should not be construed as being limited to the embodiments set forth herein. Rather, these embodiments are provided so that the present disclosure will be through and complete and so as to fully convey the scope of the present disclosure to one having ordinary skill in the art. The present disclosure will only be defined according to the appended claims. Throughout the specification, like reference numerals denote like elements.

In the drawings, thickness of layers and sections is exaggerated for clarity of description of the layers and sections. Additionally, in the drawings, thickness of some layers and sections is exaggerated for convenience of description.

Further, in this specification, when one part of a layer, a film, a section, a plate, and the like is referred to as being “on” another part or “in the upper portion” of another part, one part is “directly on” another part, and a third part is between one part and another part. On the contrary, when one part is referred to as being “directly on” another part, there is no third part between one part and another part. When one part of a layer, a film, a section, a plate, and the like is referred to as being “under” another part or “in the lower portion” of another part, one part is “directly under” another part, and a third part is between one part and another part. On the contrary, when one part is referred to as being “directly under” another part, there is no third part between one part and another part.

In one embodiment of the present disclosure, a core material for a sandwich panel is provided which includes a first polyester-based fiber that is a monocomponent fiber; and a second polyester-based fiber that is a sheath-core type bicomponent fiber.

The core material according to one embodiment of the present disclosure is applied to a sandwich panel. A sandwich panel is referred to as a panel that has a sandwich structure in which a surface material is disposed on both surfaces of a core material. The core material according to one embodiment of the present disclosure may have a strong interfacial bond with the surface materials disposed on both surfaces of the core material and may have flexibility and a flexural property such that the core material is easily deformed into a desired shape in the bending process or the deep drawing process of the surface material.

The core material for a sandwich panel, in which two sorts of polyester-based fibers are mixed and included, has the above-described properties. Specifically, the core material for a sandwich panel includes a first polyester-based fiber that is a monocomponent fiber, and a second polyester-based fiber that is a sheath-core type bicomponent fiber.

The core material may be non-woven fabric that consists of the first polyester-based fiber and the second polyester-based fiber. A weight ratio of the first polyester-based fiber to the second polyester-based fiber in the core material may be approximately 30:70 to approximately 70:30, for instance, approximately 30:70 to approximately 50:50, and, for instance, approximately 30:70 to approximately 40:60. When a sandwich panel is manufactured using the core material that has the above range of weight ratios, the core panel may have a curved shape while maintaining an interfacial bond with a surface material. Additionally, the core material may have high strength and formability because the core material has strength and rigidity higher than a conventional core material.

Further, the first polyester-based fiber may have melting points of about 200° C. to about 280° C. and, for instance, about 250° C. to about 270° C. In this specification, melting points of a fiber composition may be adjusted with a method for adjusting a degree of crystallinity in the process of manufacturing or a following process, and the like. A melting point of the same sort of fiber compositions may be adjusted such that the same sort of fiber compositions has different melting points. When the first polyester-based fiber has the above range of melting points, a random network structure that has proper porosity may be easily formed in the process of manufacturing a sandwich panel using the core material for a sandwich panel, and a sandwich panel including the core material may ensure excellent workability and formability.

Any polyester-based fiber having the above range of melting points may be used for the first polyester-based fiber that consists of a monocomponent and, for instance, may include polyethylene terephthalate (PET).

The second polyester-based fiber is a bicomponent fiber and includes a core part and a sheath part that encircles the core part. Specifically, the core part includes high melting point polyester that has relatively high melting points while the sheath part includes low meting point polyester that has relatively low melting points.

The high melting point polyester has melting points of about 200° C. to about 280° C. and, for instance, about 250° C. to about 270° C. When the core part of the second polyester-based fiber includes high melting point polyester having the above range of melting points, a random network structure that has proper porosity may be easily formed in the process of manufacturing a sandwich panel using the core material for a sandwich panel, and a sandwich panel including the core material may ensure excellent workability and formability.

Any polyester having the above range of melting points may be used for the high melting point polyester and, for instance, may include polyethylene terephthalate (PET).

The low melting point polyester has melting points of about 100° C. or more to about less than 200° C. and, for instance, about 160° C. to about 180° C. When the sheath part of the second polyester-based fiber includes low meting point polyester having the above range of melting points, the sheath part is flexibly deformed in the process of manufacturing a sandwich panel using the core material for a sandwich panel so as to properly bind the first polyester-based fiber, and the core part that includes the high melting point polyester. Thus, the core material may be formed into a random network structure that has proper porosity, and a sandwich panel including the core material may ensure excellent workability and formability.

Any polyester having the above range of melting points may be used for the low melting point polyester and, for instance, may include polyethylene terephthalate (PET).

The core material for a sandwich panel according to one embodiment of the present disclosure may not further include a separate matrix resin, a separate binder or a separate adhesive.

In general, in a sheet such as non-woven fabric that is manufactured using fiber, and the like, a plurality of strands of fiber are arranged in parallel or in an undetermined direction, are bound using matrix resins, adhesives or binders and are manufactured in the form of felt. In this case, matrix resins, adhesives or binders need to be additionally impregnated into, sprayed onto, or applied to the fiber, thereby leading to a decrease in efficiency of processing. Additionally, a random network structure that has proper porosity is hardly formed because the matrix resins, adhesives or binders fill pores formed between the plurality of strands of fiber.

Thus, the core material for a sandwich panel does not further include a separate matrix resin, a separate binder or a separate adhesive. The strands of fiber strands may be bound by the first polyester-based resin and the second polyester-based resin, and, as a result, a random network structure that has proper porosity may be formed.

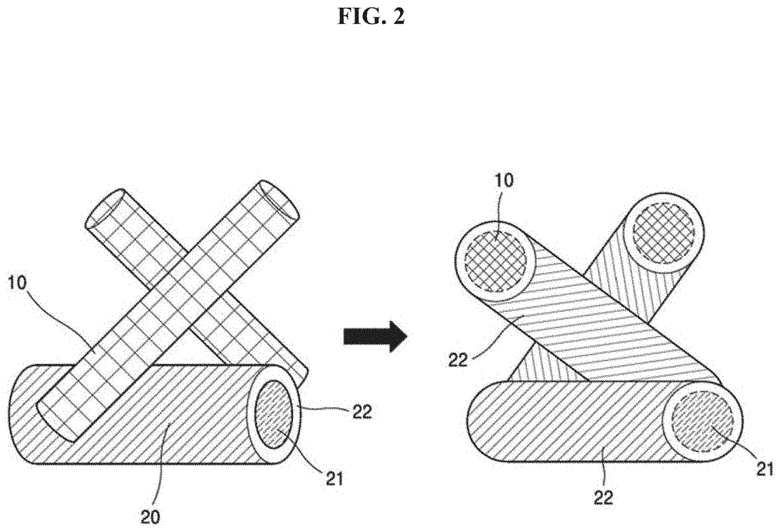

FIG. 2 is a schematic view illustrating a first polyester-based fiber and a second polyester-based fiber of a core material for a sandwich panel according to one embodiment of the present disclosure.

Referring to FIG. 2, the core material for a sandwich panel includes a first polyester-based fiber 10 that is a monocomponent fiber and a second polyester-based fiber 20 that is a sheath-core type bicomponent fiber.

In the core material for a sandwich panel, low melting point polyester that constitutes a sheath part 22 of the second polyester-based fiber 20 is flexibly deformed at a certain temperature in the process of manufacturing a sandwich panel using the core material for a sandwich panel. Accordingly, at least a part of the low melting point polyester melts, forms a coating part on a part of the surface or on the entire surface of each of the first polyester-based fiber 10 and the core part 21 of the second polyester-based fiber 20 and binds the first polyester-based fiber 10 and the core part 21 of the second polyester-based fiber 20.

That is, the first polyester-based fiber 10 and the core part 21 of the second polyester-based fiber 20 all maintain the shape of fiber at a temperature at which low melting point polyester of the sheath part 22 is flexibly deformed, and the sheath part 22 that includes the low melting point polyester serves as a medium for binding the first polyester-based fiber 10 and the core part 21 of the second polyester-based fiber 20. Thus, the core material for a sandwich panel may be formed into a random network structure that has proper porosity.

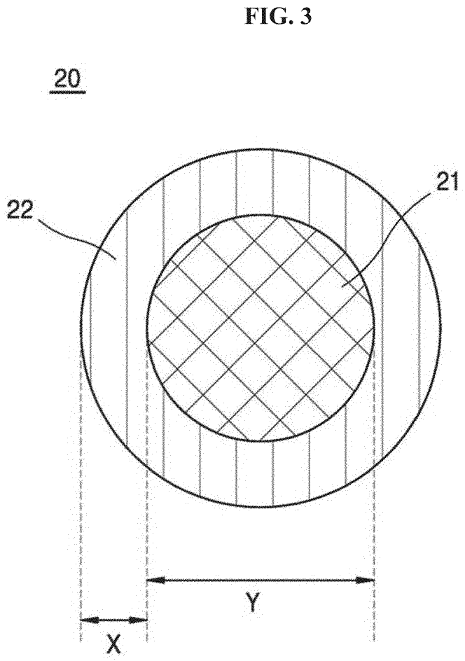

FIG. 3 is a schematic view illustrating a cross section of the second polyester-based fiber 20, cut in a direction perpendicular to a length-wise direction of the second polyester-based fiber 20.

Referring to FIG. 3, in the second polyester-based fiber, a ratio of thickness (X) of the sheath part to diameter (Y) of the core part may be approximately 1:2 to approximately 1:5. That is, the second polyester-based fiber may have a structure where the surface of the core part 21 is coated with the sheath part 22 of a thickness that is ½ to ⅕ of the diameter of the core part. With the structure, the second polyester-based fiber is mixed with the first polyester-based fiber to have a proper range of porosity, and the core material may play an important role in improving formality.

Each of the first polyester-based fiber and the second polyester-based fiber may have a cross section the average diameter of which is about 10 μm to about 60 μm and may have an average length of about 3 mm to about 60 mm. When the first polyester-based fiber and the second polyester-based fiber have the above range of average diameters and average lengths, the core material for a sandwich panel, where the fibers are tangled, may have porosity adequate for the processes of bending and deep drawing. The average diameter of the cross sections of the fibers denotes a number average diameter of the cross sections of the fibers, cut in a direction perpendicular to a lengthwise direction of the fibers.

Specifically, an average diameter of the cross section of the first polyester-based fiber may range, for instance, from about 5 μm to about 51 μm and, for instance, from about 12 μm to about 24 μm. Additionally, an average length of the first polyester-based fiber may range from about 6 mm to about 60 mm and, for instance, from about 40 mm to about 60 mm.

An average diameter of the cross section of the second polyester-based fiber, for instance, may range from about 5 μm to about 20 μm. The average diameter of the cross section of the second polyester-based fiber denotes an average diameter of the cross section of the second polyester-based fiber including the core part and sheath part. Additionally, an average length of the second polyester-based fiber may range from about 6 mm to about 60 mm and, for instance, from about 40 mm to about 60 mm.

When each of the first polyester-based fiber and the second polyester-based fiber has the above range of average diameters of a cross section and average lengths, the core material for a sandwich panel may be applied to a sandwich panel and have proper porosity. The core material may maintain an interfacial bond with the surface material and may be easily formed into a desired shape in the processes of bending and deep drawing.

In another embodiment of the present disclosure, a sandwich panel is provided which includes a core material derived from the core material for a sandwich panel; and a surface material disposed on both surfaces of the core material.

The sandwich panel has a structure where a core material manufactured from a core material for a sandwich panel including a first polyester-based fiber that is a monocomponent fiber; and a second polyester-based fiber that is a sheath-core type bicomponent fiber, and a surface material on both surfaces of the core material are included. The first polyester-based fiber and the second polyester-based fiber are the same as the above-described first polyester-based fiber and second polyester-based fiber.

A single layer or multiple layers of the core material for a sandwich panel may be formed as the core material.

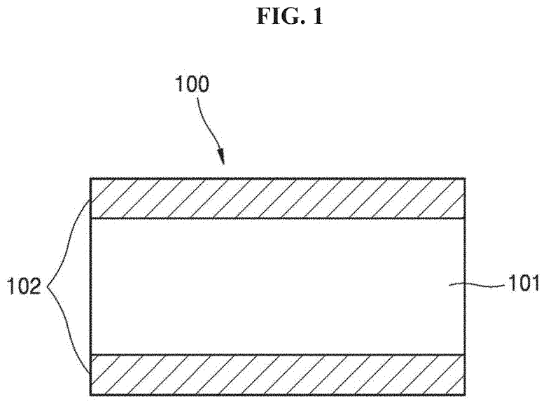

FIG. 1 is a schematic view illustrating a cross section of the sandwich panel 100 according to one embodiment of the present disclosure. Referring to FIG. 1, the sandwich panel 100 includes a core material for a sandwich panel 101, and a surface material 102 disposed on both surfaces of the core material 101.

The core material 101 has the structure of a random network that includes pores and, as described above, may be manufactured using a core material for a sandwich panel that includes the first polyester-based fiber and second polyester-based fiber. The core material 101 with the structure of a random network that includes pores may be more easily bent and pulled than that with a dense structure where pores are not substantially included and may be formed into a desired shape while maintaining an interfacial bond with the surface material 102.

The porosity of the core material may be about 40 volume % to about 80 volume % and, for instance, about 50 volume % to about 60 volume %. With the above range of porosity, the core material for a sandwich panel may have improved workability and formability

Additionally, the core material for a sandwich panel may have basis weight that ranges from about 100 g/m² to about 3000 g/m² based on thicknesses of about 0.1 mm to about 5 mm. The term “basis weight” denotes weight (g) per 1 m² of the core material. The core material for a sandwich panel with the above range of basis weight may become lighter and may have strength.

In the sandwich panel, the core material may have thickness that ranges from about 0.1 mm to about 5 mm, for instance, from about 0.2 mm to about 2.2 mm and, for instance, from about 0.2 mm to about 1.0 mm. When the core material has the above range of thicknesses, the core material may be thinner, lighter and stronger than a conventional core material for a sandwich panel. Thus, the core material may be used for home appliances, vehicles or buildings. Further, the sandwich panel that includes the core material having the above range of thicknesses may be easily processed in the process of bending and deep drawing while maintaining an interfacial bond between the core material and the surface material.

In the sandwich panel, the core material may have density that ranges from about 0.5 g/cm³ to about 1.2 g/cm³, for instance, from about 0.5 g/cm³ to about 1.0/cm³, and for instance, from about 0.6 g/cm³ to about 0.7 g/cm³. The sandwich panel that includes the core material of the above range of density may become lighter, and the core material having the above range of basis weight and porosity may ensure excellent durability and formability.

The core material may be manufactured through dry processing. Specifically, the core material for a sandwich panel includes a first polyester-based fiber that is a monocomponent fiber, and a second polyester-based fiber that is a sheath-core type bicomponent fiber and may be manufactured by dry-processing the first polyester-based fiber and second polyester-based fiber. Because the core material is manufactured through dry processing, a solvent that is harmful to the human body, and the like are not used and do not have to be withdrawn for reuse and disposal, and the core material may have uniform bending and tensile properties.

Specifically, a difference in flexural strength of the core material in two predetermined perpendicular directions may be about 4 MPa or less and, for instance, may be 0 (zero) MPa. The term “flexural strength” denotes a maximum load value when flexural pressure that bends an object is applied. The core material has uniform flexural strength across the surface area thereof. Accordingly, the core material may be easily formed and processed and may be used for various purposes.

Additionally, a difference in flexural modulus of the core material in two predetermined perpendicular directions may be about 0.5 GPa or less, for instance, about 0.1 GPa or less and, for instance, may be 0 (zero) GPa. The term “flexural modulus” denotes a ratio of stress, applied in a section where applied stress is proportional to strain, to strain. The core material has uniform flexural modulus across the surface area thereof. Accordingly, the core material may be easily formed and processed and may be used for various purposes.

Referring to FIG. 1, the sandwich panel 100 includes a surface material 102 disposed on both surfaces of the core material 101. FIG. 1 illustrates the surface material 102 in direct contact with both surfaces of the core materials 101.

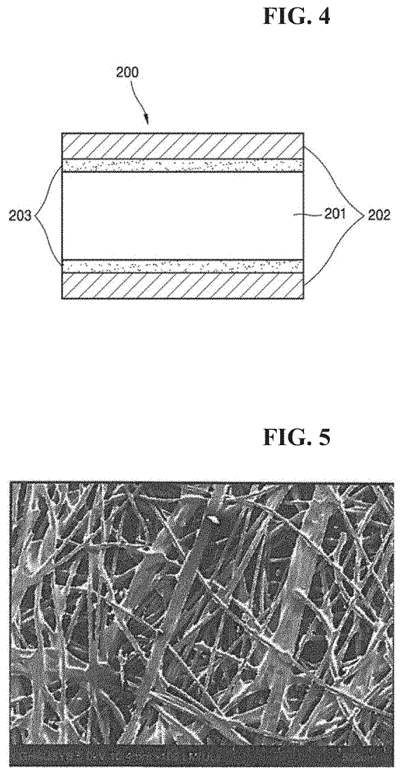

FIG. 4 is a schematic view illustrating a cross section of a sandwich panel 200 according to another embodiment of the present disclosure. Referring to FIG. 4, the sandwich panel 200 includes the core material 201 and a surface material 202 on both surfaces of the core material 201 and may further include an adhesive layer 203 between the core material 201 and the surface material 202.

The adhesive layer 203 includes an adhesive and may include any one selected from a group consisting of a urethane-based adhesive, an acrylic-based adhesive, an epoxy-based adhesive and a combination thereof.

In one embodiment, the adhesive layer 203 may include an epoxy-based adhesive and, specifically, may include an elastic epoxy adhesive. The elastic epoxy adhesive may attach the core material to the surface material more firmly than any other adhesive, and the sandwich panel may ensure excellent formability resulting from elasticity of the adhesive.

When the sandwich panel 200 further includes an adhesive layer 203 between the core material 201 and the surface material 202, the adhesive layer may have thickness of about 10 μm to about 50 μm.

The core material 201 has the structure of a random network with predetermined porosity. Accordingly, adhesive ingredients of the adhesive layer 203 may flow into the core material. The adhesive ingredients are chemically or physically combined with ingredients of the core material 201 such that adhesiveness between the core material 201 and the surface material 202 may increase. However, when an excessive amount of the adhesive ingredients flows into the core material, the adhesive ingredients may fill space between fibers and, as a result, may damage the random network structure of the core material.

When the adhesive layer 203 is configured to have thickness of about 10 μm to about 50 μm, the core material 201 may maintain the above range of porosity and, at the same time, may increase adhesiveness between the core material 201 and the surface material 202.

Additionally, when the first polyester-based fiber and second polyester-based fiber of the core material 201 have the above range of weight ratios, and the adhesive layer 203 has the above range of thicknesses, the random network structure of the core material 201 may be readily maintained.

The surface material 102, 202 may include any one selected from a group consisting of iron, stainless steel (SUS), galvanized sheet iron (EGI), aluminum, magnesium, copper and a combination thereof. The surface material is the outermost layer of the sandwich panel. The surface material is a surface that is directly processed and formed when the sandwich panel is processed and formed and a layer that contacts the outside when the sandwich panel is applied to a product. The surface material 102, 202 made of the above-described materials may be highly bent and deformed while maintaining an interfacial bond with the core material for a sandwich panel and may ensure excellent durability after the sandwich panel is applied to a final product.

The surface material may have thickness that ranges from about 0.05 mm to about 0.5 mm and, for instance, from about 0.3 mm to about 0.5 mm. When the surface material has the above range of thicknesses, the surface material may be bent into a desired shape with proper strength, and the sandwich panel may be thin as a whole and may ensure excellent formability and strength.

The sandwich panel that includes the core material and the surface material disposed on both surfaces of the core material may have uniform physical properties across the surface area thereof, may ensure excellent formability and may become lighter.

Specifically, a difference in flexural strength of the sandwich panel in two predetermined perpendicular directions may be about 3 MPa or less and, for instance, may be 0 (zero) MPa. The term “flexural strength” denotes a maximum load value when flexural pressure that bends an object is applied.

Additionally, a difference in flexural modulus of the sandwich panel in two predetermined perpendicular directions may be about 2 GPa or less and, for instance, may be 0 (zero) GPa. The term “flexural modulus” denotes a ratio of stress, applied in a section where applied stress is proportional to strain, to strain.

When a difference in flexural strength and flexural modulus of the sandwich panel in two predetermined perpendicular directions is within the above range of differences, the sandwich panel may have uniform physical properties across the surface area thereof, may have improved formality and workability and may be used for various purposes.

In yet another embodiment of the present disclosure, a method for manufacturing a sandwich panel is provided. Specifically, the method for manufacturing a sandwich panel includes mixing a first polyester-based fiber that is a monocomponent fiber and a second polyester-based fiber that is a sheath-core type bicomponent fiber; manufacturing a core material from the mixed fibers through dry processing; and disposing a surface material on both surfaces of the core material, heating and pressurizing the same.

The above-described sandwich panel may be manufactured with the method for manufacturing a sandwich panel.

The method for manufacturing a sandwich panel includes mixing a first polyester-based fiber that is a monocomponent fiber and a second polyester-based fiber that is a sheath-core type bicomponent fiber. The first polyester-based fiber and second polyester-based fiber are physically mixed.

In this case, each of the first polyester-based fiber and the second polyester-based fiber may have a cross section the average diameter of which ranges from about m to about 60 μm and may have an average length that ranges from about 3 mm to about 60 mm. When the first polyester-based fiber and the second polyester-based fiber have the above range of average diameters of a cross section and average lengths, the fibers may be evenly mixed, and then the process of manufacturing a core material from the mixed fibers may be efficiently performed.

The method includes manufacturing a core material from the mixed first polyester-based fiber and second polyester-based fiber through dry processing. Specifically, in the dry processing, a solvent, and the like that contain substances harmful to the human body are not used, and the process of withdrawing a solvent, and the like is omitted, thereby ensuring efficiency of processing. Additionally, a manufactured sandwich panel may have uniform tensile and flexural properties across the surface area thereof through the process.

Specifically, the dry processing may involve air layering, needle punching or stitch bonding.

Air layering is a process of evenly dispersing the mixed first polyester-based fiber and second polyester-based fiber using compressed air and forming the same into a sheet. In the dry processing, fibers of lengths that are hardly treated in wet processing may be readily treated, and fibers may be evenly dispersed.

Needle punching is a process of punching the mixed first polyester-based fiber and second polyester-based fiber with needles and physically forming the same into a web. In the process of needle punching, the number of punching the fibers and the density of needles may be properly adjusted such that the fibers may have desired physical properties.

Stitch bonding is a process of sewing the mixed first polyester-based fiber and second polyester-based fiber with thread and processing the same into a sheet. In the process of stitch bonding, proper basis weight and high tensile strength may be ensured.

The method for manufacturing a sandwich panel includes heating and pressurizing a core material that is manufactured from the mixed fibers through the dry processing.

The core material includes the first polyester-based fiber and second polyester-based fiber. Accordingly, in the process of heating and pressurizing the core material and a surface material disposed on both surfaces of the core material, the core material may ensure an interfacial bond with the surface material above a certain level while maintaining proper porosity.

The second polyester-based fiber includes a core part and a sheath part that encircles the core part. Specifically, the core part includes high melting point polyester having melting points of about 200° C. to about 280° C. while the sheath part includes low melting point polyester having melting points of about 100° C. or more to about less than 200° C. In the heating and pressurizing step, the low melting point polyester of the sheath part melts, forms a coating part on a part of the surface or the entire surface of each of the first polyester-based fiber and the high melting point polyester and binds the first polyester-based fiber and the high melting point polyester. Accordingly, a random network structure that includes pores may be formed.

In the heating and pressurizing step, a temperature for heating the core material may be higher than a melting point of the sheath part and may be lower than a melting point of the core part and the first polyester-based fiber. Pressure may range from about 0.4 Mpa to about 1.0 MPa. Processed at the above-described temperature and pressure, the sandwich panel may have a proper thickness and maintain the structure of a random network that has proper porosity. Thus, the sandwich panel may ensure excellent formability in the processes of bending, deep drawing, and the like.

Porosity of the core material manufactured as described above may be about 40 volume % to about 80 volume % and, for instance, about 50 volume % to about 60 volume %. Additionally, basis weigh of the core material may be about 100 g/m² to about 3000 g/m² based on thickness of about 0.1 mm to about 5 mm, and density of the core material may be about 0.5 g/cm³ to about 1.2 g/cm³. When the core material has the above range of porosity, basis weight and density, the sandwich panel may be used for various purposes and may have excellent formability and durability.

The method for manufacturing a sandwich panel may further include disposing a surface material respectively on both surfaces of the core material. The surface material is the same as the above-described surface material.

The method for manufacturing a sandwich panel may further include applying an adhesive onto both surfaces of the core material prior to the step of disposing a surface material.

The adhesive, for instance, may include any one selected from a group consisting of a urethane-based adhesive, an acrylic-based adhesive, an epoxy-based adhesive and a combination thereof.

In one embodiment, the adhesive may include an epoxy-based adhesive and, specifically, may include an elastic epoxy adhesive. The elastic epoxy adhesive may attach the core material to the surface material more firmly than any other adhesive, and, accordingly, the sandwich panel may ensure excellent formability.

When about 10 μm to about 50 μm of the adhesive is applied on both surfaces of the core material, an adequate amount of ingredients of the adhesive flows into the structure of a random network having predetermined porosity of the core material. Accordingly, the ingredients of the adhesive are chemically and physically combined with ingredients of the core material so as to increase adhesion between the core material and the surface material, and at the same time, the core material may maintain the structure of a random network that has proper porosity, thereby making it possible to ensure excellent formability and lightweight properties.

In the method for manufacturing a sandwich panel including the step of applying an adhesive on both surfaces of the core material, when the surface material is disposed on the applied adhesive and then heated and pressurized, a sandwich panel may be manufactured.

Below, embodiments of the present disclosure will be described. However, the below-described embodiments are provided only as examples. Therefore, the present disclosure should not be limited to the embodiments.

### Embodiments and Comparative Examples

### Embodiment 1

polyethylene terephthalate (PET) monocomponent fiber that had an average diameter of a cross section of 12 μm, an average length of 51 mm and a melting point ranging from 250° C. to 270° C. was used as a first polyester-based fiber. A core part including high melting point polyethylene terephthalate (PET) that had an average diameter of a cross section of 20 μm, an average length of 51 mm and a melting point ranging from 250° C. to 270° Q and a sheath-core type bicomponent fiber including low melting point polyethylene terephthalate (PET) that had a melting point ranging from 160° C. to 180° C. were used as a second polyester-based fiber. In this case, a diameter of the core part was 12 μm, and a thickness of the sheath part was 4 μm. The first polyester fiber and the second polyester fiber were mixed based on the weight ratio of 40:60.

Next, the mixed fibers were processed through air layering, and then a core material for a sandwich panel was manufactured.

Next, an elastic epoxy adhesive was applied on both surfaces of the core material for a sandwich panel, and, on top of it, a 0.4 mm-thick-aluminum plate was disposed respectively as a surface material and heated and pressurized at temperature of 100° C. at pressure of 0.7 M Pa. Thus, a sandwich panel that included a core material having an entire thickness of 2.3 mm, porosity of 50 volume %, basis weight of 1000 g/m² and density of 0.6 g/cm³ and that included a surface material on both surfaces of the core material was manufactured.

### Embodiment 2

A sandwich panel was manufactured with a method the same as that of embodiment 1, except that the mixed fibers were processed through needle punching dry processing so as to manufacture a core material for a sandwich panel.

### Comparative Example 1

A sandwich panel was manufactured with the same method as that of embodiment 1, except that a core material in which zinc oxide (ZnO) was included in a polyethylene matrix resin and which had porosity of 0 volume % and density of about 1.55 g/cm³ was used.

### Comparative Example 2

The mixed fibers were stirred in a solution of pH2 for one hour and then a wet-laid paper process was performed to form slurry of the stirred solution into a web in a headbox with a vacuum suction device. Then a sandwich panel was manufacture with a method the same as that of embodiment 1, except that moisture was completely dried with an oven dryer after the web was formed so as to manufacture a core material that had porosity of 40 volume %, basis weight of 130 g/m² and density of 0.6 g/cm³.

### <Estimation>

### Experimental Example 1

FIG. 5 is an SEM image illustrating a cross section of a core material of a sandwich panel manufactured in embodiment 1. FIG. 5 clearly illustrates a structure of a random network having certain porosity, in which a sheath part of a second polyester-based fiber melts and forms a coating part on a part of the surface or on the entire surface of each of the first polyester-based fiber and the core part of the second polyester-based fiber and binds the first polyester-based fiber and the core part of the second polyester-based fiber.

### Experimental Example 2

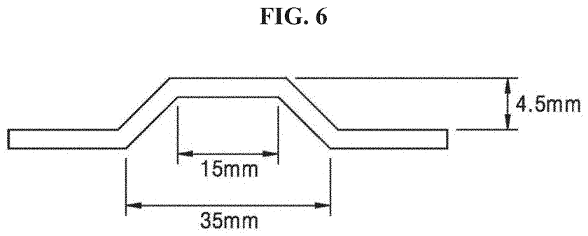

The process of deep drawing was performed to each of the sandwich panels manufactured in embodiments 1 to 2 and comparative examples 1 to 2 such that a cross section of the lateral surfaces of the sandwich panels was formed into the shape illustrated in FIG. 6. It turned out that deep drawing was possible for the sandwich panels manufactured in embodiments 1 to 2 and comparative example 2 and that the sandwich panels could be formed into a desired shape without interfacial peeling between layers. On the other hand, the sandwich panel manufactured in comparative example 1 experienced interfacial peeling between layers, and a processed shape had a crack. It turned out that deep drawing was impossible for the sandwich panel manufactured in comparative example 1.

TABLE 1

| | Formality in |
|---|---|
| Sort | deep drawing |
| Embodiment 1 | Possible |
| Embodiment 2 | Possible |
| Comparative | Impossible |
| example 1 | |
| Comparative | Possible |
| example 2 | |

### Experimental Example 3

Flexural strength and flexural modulus of the core material of each of the sandwich panels manufactured in embodiments 1 to 2 and comparative examples 1 to 2 were measured in the machine direction (MD) and in the transverse direction (TD). The core material was 2.3 mm thick. The flexural strength and flexural modulus were measured with a universal testing machine (INSTRON 5569A) using the method of ASTM C393. The results are shown in table 2, below.

TABLE 2

| | | Flexural | Flexural |
|---|---|---|---|
| | | strength | modulus |
| Sort | Direction | (MPa) | (GPa) |
| Embodiment 1 | MD | 28.4 | 1.1 |
| | TD | 28.4 | 1.1 |
| Embodiment 2 | MD | 30.2 | 1.1 |
| | TD | 26.6 | 1.0 |
| Comparative | MD | 26.9 | 1.5 |
| example 1 | TD | 26.9 | 1.5 |
| Comparative | MD | 36.0 | 1.5 |
| example 2 | TD | 25.9 | 1.0 |

### Experimental Example 4

Flexural strength and flexural modulus of each of the sandwich panels manufactured in embodiments 1 to 2 and comparative examples 1 to 2 were measured in the machine direction (MD) and in the transverse direction (TD). The flexural strength and flexural modulus were measured with a universal testing machine (INSTRON 5569A) using the method of ASTM C393. The results are shown in table 3, below.

TABLE 3

| | | Flexural | Flexural |
|---|---|---|---|
| | | strength | modulus |
| Sort | Direction | (MPa) | (GPa) |
| Embodiment 1 | MD | 171 | 49.0 |
| | TD | 171 | 49.0 |
| Embodiment 2 | MD | 173 | 49.7 |
| | TD | 170 | 48.0 |
| Comparative | MD | 169.4 | 49.8 |
| example 1 | TD | 169.4 | 49.8 |
| Comparative | MD | 180.2 | 50.6 |
| example 2 | TD | 176.2 | 49.3 |

Referring to the results in table 1 and 2, unlike the core materials in comparative examples 1 to 2, physical properties of the core materials in embodiments 1 to 2 make little difference in the machine direction and in the transverse direction, and the core material in embodiments 1 to 2 may ensure excellent formality in the process of deep drawing.

1. A core material for a sandwich panel, comprising:
a first polyester-based fiber that is a monocomponent fiber; and a second polyester-based fiber that is a sheath-core type bicomponent fiber.

2. The core material for a sandwich panel of claim 1, wherein a weight ratio of the first polyester-based fiber to the second polyester-based fiber is 30:70 to 70:30.

3. The core material for a sandwich panel of claim 1, wherein the core material for a sandwich panel does not further include a separate matrix resin, a separate binder or a separate adhesive.

4. The core material for a sandwich panel of claim 1, wherein the second polyester-based fiber comprises a core part and a sheath part that encircles the core part,
the core part comprises high melting point polyester having a melting point of 200° C. to 280° C., and the sheath part comprises low melting point polyester having a melting point of 100° C. or more to less than 200° C.

5. The core material for a sandwich panel of claim 1, wherein the first polyester-based fiber has a melting point of 200° C. to 280° C.

6. The core material for a sandwich panel of claim 1, wherein an average diameter of a cross section of each of the first polyester-based fiber and the second polyester-based fiber is 10 μm to 60 μm, and an average length of each of the first polyester-based fiber and the second polyester-based fiber is 3 mm to 60 mm.

7. A sandwich panel, comprising:
a core material derived from the core material of a sandwich panel according to claim 1; and a surface material disposed on both surfaces of the core material.

8. The sandwich panel of claim 7, wherein the core material has a random network structure that includes pores and has porosity of 40 volume % to 80 volume %.

9. The sandwich panel of claim 7, wherein the core material has basis weight of 100 g/m² to 3000 g/m² based on thickness of 0.1 mm to 5 mm.

10. The sandwich panel of claim 7, wherein the core material has thickness of 0.1 mm to 5 mm.

11. The sandwich panel of claim 7, wherein the core material has density of 0.5 g/cm³ to 1.2 g/cm³.

12. The sandwich panel of claim 7, wherein a difference in flexural strength of the core material measured in any two perpendicular directions is 4 MPa or less.

13. The sandwich panel of claim 7, wherein a difference in flexural modulus of the core material measured in any two perpendicular directions is 0.5 GPa or less.

14. The sandwich panel of claim 7, wherein the surface material comprises any one selected from a group consisting of iron, stainless steel (SUS), galvanized sheet iron (EGI), aluminum, magnesium, copper and a combination thereof.

15. The sandwich panel of claim 7, wherein the surface material has thickness of 0.05 mm to 0.5 mm.

16. A method for manufacturing a sandwich panel, comprising:
mixing a first polyester-based fiber that is a monocomponent fiber and a second polyester-based fiber that is a sheath-core type bicomponent fiber;
manufacturing a core material from the mixed fibers through dry processing; and
heating and pressurizing the core material.

17. The method for manufacturing a sandwich panel of claim 16, wherein the second polyester-based fiber comprises a core part and a sheath part that encircles the core part,
the core part comprises high melting point polyester having a melting point of 200° C. to 280° C., and the sheath part comprises low melting point polyester having a melting point of 100° C. or more to less than 200° C.,
in the heating and pressurizing step, the low melting point polyester of the sheath part melts, forms a coating part on a part of the surface or on the entire surface of each of the first polyester-based fiber and the core part including the high melting point polyester and binds the first polyester-based fiber and the core part, and then a random network structure that includes pores is formed.

18. The method for manufacturing a sandwich panel of claim 16, wherein the dry processing is performed using air layering, needle punching, stitch bonding or melt blowing.

19. The method for manufacturing a sandwich panel of claim 16, wherein the method further comprises disposing a surface material on both surfaces of the core material.
